(19) United States
(12) Patent Application Publication
(10) Pub. No.: US 2013/0321897 A1
(43) Pub. Date: Dec. 5, 2013

(54) PHOTOREFRACTIVE DEVICES HAVING SOL-GEL BUFFER LAYERS AND METHODS OF MANUFACTURING

(71) Applicants: Peng Wang, San Diego, CA (US); Sergey Simavoryan, San Diego, CA (US); Weiping Lin, Carlsbad, CA (US); Wan-Yun Hsieh, San Diego, CA (US); Michiharu Yamamoto, Carlsbad, CA (US)

(72) Inventors: Peng Wang, San Diego, CA (US); Sergey Simavoryan, San Diego, CA (US); Weiping Lin, Carlsbad, CA (US); Wan-Yun Hsieh, San Diego, CA (US); Michiharu Yamamoto, Carlsbad, CA (US)

(73) Assignee: NITTO DENKO CORPORATION, Osaka (JP)

(21) Appl. No.: 14/000,181

(22) PCT Filed: Feb. 17, 2012
(86) PCT No.: PCT/US12/25617

§ 371 Date: Aug. 16, 2013

Related U.S. Application Data
(60) Provisional application No. 61/444,605, filed on Feb. 18, 2011.

(51) Int. Cl. G02F 1/29

(52) U.S. Cl. CPC G02F 1/293
USPC 359/299; 156/313

(57) ABSTRACT

A photorefractive device (100) and methods of its manufacture are disclosed. The photorefractive device (100) comprises one or more transparent electrode layers (104), one or more sol-gel buffer layers (113), one or more polymer buffer layers (105), and a photorefractive layer (106). The one or more sol-gel buffer layer (113) is interposed between the one or more polymer buffer layer (105) and the one or more transparent electrode layer (104). When a bias voltage is applied to the device (100), the device (100) exhibits improvement in electric breakdown strength compared to a similar device without the one or more dielectric sol-gel buffer layers (113). The device (100) can operate at high bias levels with quick rising and decay times and shows higher grating performance under single nanosecond pulse recording conditions.

### CROSS-REFERENCE TO RELATED APPLICATIONS

The present application claims priority under 35 U.S.C. §119(e) to U.S. Provisional Application No. 61/444,605 filed on Feb. 18, 2011, the disclosures of which is incorporated by reference herein in its entirety.

### STATEMENT REGARDING FEDERALLY SPONSORED R&D

This invention was made with government support under FA8650-10-C-7034 awarded by the Office of the Director of National Intelligence (ODNI), Intelligence Advance Research Projects Activity (IARPA), through the Air Force Research Laboratory (AFRL). The government has certain rights in the invention.

### BACKGROUND OF THE INVENTION

1. Field of the Invention

The invention relates to photorefractive devices and fabrication methods for improving the performances of photorefractive devices using one or more sol-gel buffer layers. The implementation of one or more sol-gel buffer layers in the photorefractive devices improves properties, such as obtaining high electric breakdown strength, high single pulse photorefractive grating performance, and fast grating rising and decay times.

2. Description of the Related Art

Photorefractivity is a phenomenon in which the refractive index of a photorefractive material can be modified by changing the electric field in the material, such as by laser beam irradiation. The change of the refractive index is carried out by: (1) charge generation by laser irradiation, (2) charge transport, resulting in the separation of positive and negative charges, (3) trapping of one type of charge (charge delocalization), (4) formation of a non-uniform internal electric field (space-charge field) as a result of charge delocalization, and (5) refractive index change induced by the non-uniform electric field. As such, good photorefractive properties can be obtained in photorefractive materials that combine good charge generation, good charge transport or photoconductivity, and good electro-optical activity.

Photorefractive materials can be used widely in a plurality of promising applications, such as 3D holographic displays, high-density optical data storage, dynamic holography, optical image processing, phase conjugated minors, signal amplification, optical computing, parallel optical logic, and pattern recognition. Originally, the photorefractive effect was found in a variety of inorganic electro-optical (EO) crystals, such as LiNbO₃. In these materials, the mechanism of the refractive index modulation by the internal space-charge field is based on a linear EO effect.

In 1990 and 1991, the first organic photorefractive crystal and polymeric photorefractive materials were discovered and reported. Such materials are disclosed, for example, in U.S. Pat. No. 5,064,264, to Ducharme et al. Organic photorefractive materials offer many advantages over the original inorganic photorefractive crystals, such as large optical nonlinearities, low dielectric constants, low cost, lightweight, structural flexibility, and ease of device fabrication. Other important characteristics that may be desirable depending on the application include sufficiently long shelf life, optical quality, and thermal stability. These kinds of active organic polymers are emerging as key materials for advanced information and telecommunication technology.

In recent years, efforts have been made to optimize the properties of organic, and particularly polymeric, photorefractive materials. As mentioned above, good photorefractive properties depend upon good charge generation, good charge transport, also known as photoconductivity, and good electro-optical activity. Various studies that investigate the selection and combination of the components that give rise to each of these features have been done. The photoconductive capability is frequently provided by incorporating materials containing carbazole groups. Phenyl amine groups can also be used for the charge transport role of the material.

Particularly, several new organic photorefractive compositions having better photorefractive performances, such as high diffraction efficiency, fast response time, and long phase stabilities have been developed. For example, see U.S. Pat. Nos. 6,809,156, 6,653,421, 6,646,107, 6,610,809, and U.S. Patent Application Publication No. 2004/0077794A1 (Nitto Denko Technical), each of which is incorporated by reference in its entirety. These publications disclose methodologies and materials to make triphenyl amine (TPD)-type photorefractive compositions which show very fast response time and good gain coefficients.

Typically, a biased voltage may be applied onto photorefractive materials in order to achieve good photorefractive behaviors. In some applications, like 3D holographic displays, dynamic holography, optical image processing, phase conjugated mirrors, signal amplification, optical computing, parallel optical logic, and pattern recognition, the higher the applied bias, the better the overall performance. For example, Tay et al., “An updatable holographic three-dimensional display,” Nature, 2008, 451, 694-698 discloses a device that shows nearly 90% internal diffraction efficiency at 4.5 KV; however, a preferred 3D holographic image recording voltage is typically set much higher at around 9.0 KV. This so-called kick-off recording method at higher bias ensures much better holographic display performance. While applying a high biased voltage may result in a better performance, the application of the high voltage in photorefractive material may also cause electrical breakdown which will lead to failure of the photorefractive device.

It is possible to protect the photorefractive devices and further enhance their performance from breakdown by providing additional polymer protection layers, as disclosed by U.S. Patent Application Publication No. 2010/0060975A1 to Nitto Denko Tech. However, good electric breakdown protection typically requires relatively thicker polymer protection layers, which may result in an increase of the grating holding time. In order to satisfy the requirement for dynamic holographic application, there is a strong need to improve electric breakdown protection performance without sacrificing the quick decay grating dynamics.

### SUMMARY OF THE INVENTION

An embodiment provides a photorefractive device, which comprises a transparent electrode layer, a sol-gel buffer layer, a polymer buffer layer, and a photorefractive layer. In an embodiment, the sol-gel buffer layer is interposed between the transparent electrode layer and the polymer buffer layer. In an embodiment, the polymer buffer layer is interposed between the sol-gel buffer layer and the photorefractive layer. The thicknesses of the sol-gel buffer layer and the polymer buffer layer can vary. Preferably, the sol-gel buffer layer has a high dielectric constant. For example, the dielectric constant of the sol-gel buffer layer can be greater than about 3.0. In an embodiment, the dielectric constant of the sol-gel buffer layer is greater than about 4.0. In an embodiment, the dielectric constant of the sol-gel buffer layer is greater than about 5.0.

An embodiment provides a photorefractive device, which comprises a first transparent electrode layer and a second transparent electrode layer, a first sol-gel buffer layer and a second sol-gel buffer layer, a first polymer buffer layer and a second polymer buffer layer, and a photorefractive layer. In an embodiment, the first electrode layer and the second electrode layer are positioned on opposite sides of the photorefractive layer. In an embodiment, the first sol-gel buffer layer and the second sol-gel buffer layer are positioned on opposite sides of the photorefractive layer. In an embodiment, the first polymer buffer layer and the second polymer buffer layer are positioned on opposite sides of the photorefractive layer. In an embodiment, the first sol-gel buffer layer is interposed between the first electrode layer and the first polymer buffer layer, and the first polymer layer is interposed between the first sol-gel buffer layer and the photorefractive layer. In an embodiment, the second sol-gel buffer layer is interposed between the second electrode layer and the second polymer buffer layer, and the second polymer buffer layer is interposed between the second sol-gel buffer layer and the photorefractive layer.

An embodiment provides a method of manufacturing a photorefractive device, comprising forming one or more transparent electrode layers, forming a photorefractive layer, interposing one or more sol-gel buffer layers between the one or more transparent electrode layers and the photorefractive layer, and interposing one or more polymer buffer layers between the one or more transparent electrode layers and the photorefractive layer.

In an embodiment, the one or more transparent electrode layers comprise first and second transparent electrode layers positioned on opposite sides of the photorefractive layer. In an embodiment, the one or more sol-gel buffer layers comprise first and second sol-gel buffer layers positioned on opposite sides of the photorefractive layer. In an embodiment, the one or more polymer buffer layers comprise first and second polymer buffer layers positioned on opposite sides of the photorefractive layer. In an embodiment, the first sol-gel buffer layer is interposed between the first electrode layer and the first polymer buffer layer, and the first polymer layer is interposed between the first sol-gel buffer layer and the photorefractive layer. In an embodiment, the second sol-gel buffer layer is interposed between the second electrode layer and the second polymer buffer layer, and the second polymer buffer layer is interposed between the second sol-gel buffer layer and the photorefractive layer.

It has been discovered that photorefractive devices produced using the materials and methods disclosed herein can achieve up to 30% and higher electric breakdown strength compared to similar devices that contain only one kind of polymer buffer layers with similar thicknesses. The addition of the sol-gel buffer layer, in combination with the polymer buffer layer, provides unexpectedly improved benefits. For example, it has also been discovered that the photorefractive devices produced using the materials and methods disclosed herein can achieve two to three times faster grating rising and decay times compared to devices containing only one kind of polymer buffer layer with similar thicknesses. Furthermore, it has also been discovered that the photorefractive devices produced using the materials and methods disclosed herein can achieve two to three times larger single pulse grating signals compared to devices containing only one kind of polymer buffer layer with similar thicknesses.

These and other embodiments are described in greater detail below.

### BRIEF DESCRIPTION OF THE DRAWINGS

FIG. 1 illustrates an embodiment of a photorefractive device comprising two transparent electrode layers, two sol-gel buffer layers, two polymer buffer layers, and a photorefractive layer.

FIG. 2 illustrates an embodiment of photorefractive device comprising two substrate layers, two transparent electrode layers, two sol-gel buffer layers, two polymer buffer layers, and a photorefractive layer.

### DETAILED DESCRIPTION OF THE PREFERRED EMBODIMENT

Described herein are photorefractive devices that comprise one or more transparent electrode layers, one or more sol-gel buffer layers, one or more polymer buffer layers, and a photorefractive layer that includes a photorefractive material. In an embodiment, the one or more sol-gel buffer layers are interposed between the one or more electrode layer and the one or more polymer buffer layers. In an embodiment, the one or more polymer buffer layers are interposed between the one or more sol-gel buffer layers and the photorefractive layer.

The one or more sol-gel buffer layers may comprise high dielectric constant material and provide electrical breakdown protection when operated at high bias. The one or more polymer buffer layers have relatively lower dielectric constant and provide enhancement for photorefractive performance. The combination of the sol-gel buffer layer and the polymer buffer layer in the photorefractive device provides multiple improved properties. It has been discovered that providing a sol-gel buffer layer in a photorefractive device allows one having ordinary skill in the art to reduce the thickness of a polymer buffer layer while simultaneously improving the properties.

In some embodiments, the photorefractive device exhibits an increased electric breakdown strength, quicker grating rising and decay time, and stronger grating signal under single laser pulse exposure relative to a second photorefractive device having only one kind of polymer protection (buffer) layer. In an embodiment, the peak diffraction efficiency bias of the photorefractive device is reduced, electric breakdown strength is improved, quicker grating rising and decay time are provided, and stronger grating signal under single laser pulse exposure is achieved relative to a photorefractive device containing at least one transparent electrode layer and a photorefractive layer without a buffer layer interposed there between. In an embodiment, the grating rising and decay time and peak diffraction bias voltage are measured using a 532 nm laser beam.

Various polymers can be used in the polymer buffer layer. In an embodiment, the polymer buffer layer comprises at least one polymer selected from the group consisting of polymethyl methacrylate (PMMA), amorphous polycarbonate (APC), polyimide, polyvinylcarbazole, and polyarylate. In an embodiment, the polymer buffer layer comprises one of amorphous polycarbonate, polyarylate and PMMA. In an embodiment, the refractive index of the one or more polymer buffer layers is in the range of from about 1.45 to about 1.7.

The thickness of the polymer buffer layer may vary over a wide range in a photorefractive device. If more than one polymer buffer layer is present in the photorefractive device, the thickness can be measured based on the total combined thicknesses of each of the polymer buffer layers. In an embodiment, the total thickness of the polymer buffer layer(s) is in the range of about 2 μm to about 16 μm. If more than one polymer buffer layer is used in the device, then the thickness of each of the polymer buffer layers may be independently selected. For example, each individual polymer buffer layer may have a thickness in the range of about 1 μm to about 16 μm. In an embodiment, an individual polymer buffer layer has a thickness in the range of about 1 μm to about 12 μm. In an embodiment, an individual polymer buffer layer has a thickness in the range of about 1 μm to about 8 μm. In an embodiment, an individual polymer buffer layer has a thickness in the range of about 2 μm to about 12 μm. In an embodiment, an individual polymer buffer layer has a thickness in the range of about 2 μm to about 8 μm. In an embodiment, an individual polymer buffer layer has a thickness in the range of about 2 μm to about 6 μm. The presence of a sol-gel buffer layer allows for one having ordinary skill in the art to reduce the thickness of the polymer buffer layer(s) compared to other devices that utilize a polymer buffer layer, such as those disclosed in U.S. Patent Application Publication No. 2010/0060975, which is incorporated herein by reference in its entirety.

In an embodiment, the sol-gel buffer layer comprises a sol-gel material or a sol-gel material precursor. Various sol-gel materials can be used. The sol-gel material or sol-gel material precursor can undergo condensation and be dried to various degrees when forming the sol-gel buffer layer. Preferably, the sol-gel buffer layer has a high dielectric constant. In an embodiment, the dielectric constant of the sol-gel buffer layer is greater than 3.0. In an embodiment, the dielectric constant of the sol-gel buffer layer is greater than 4.0. In preferred embodiments, the dielectric constant of the sol-gel buffer layer is greater than 5.0.

The thickness of the sol-gel buffer layer may vary over a wide range in a photorefractive device. If more than one sol-gel buffer layer is present in the photorefractive device, the thickness can be measured based on the total combined thicknesses of each of the sol-gel buffer layers. In an embodiment, the total thickness of the sol-gel buffer layer(s) is in the range of about 0.2 μm to about 4 μm. If more than one sol-gel buffer layer is used in the device, then the thickness of each of the sol-gel buffer layers may be independently selected. For example, each individual sol-gel buffer layer may have a thickness in the range of about 0.1 μm to about 4 μm. In an embodiment, an individual sol-gel buffer layer has a thickness in the range of about 0.1 μm to about 2 μm. In an embodiment, an individual sol-gel buffer layer has a thickness in the range of about 0.1 μm to about 1 μm. In an embodiment, an individual sol-gel buffer layer has a thickness in the range of about 0.2 μm to about 2 μm. In an embodiment, an individual sol-gel buffer layer has a thickness in the range of about 0.2 μm to about 1 μm.

In a further embodiment, each transparent electrode layer of the device comprises a conductive film selected from the group consisting of metal oxides, metals, and organic films. In an embodiment, the conductive film has an optical density of 0.2 or less. In an embodiment, the electrode layer comprises a material selected from the group consisting of indium tin oxide, tin oxide, zinc oxide, gold, aluminum, poly(3,4-ethylenedioxythiophene (PEDOT), polythiophene, polyaniline, and combinations thereof.

The photorefractive layer comprises a material that exhibits photorefractive behavior, and it may comprise one or more polymers or an inorganic substance. In an embodiment, the photorefractive layer comprises organic or inorganic polymers exhibiting high photorefractive behavior and having a refractive index of about 1.7.

In an embodiment, the photorefractive device further comprises one or more substrates on a side of the one or more electrode layers that is opposite the one or more sol-gel buffer layers. In an embodiment, the substrate comprises a material selected from the group consisting of soda lime glass, silica glass, borosilicate glass, gallium nitride, gallium arsenide, sapphire, quartz glass, polyethylene terephthalate, and polycarbonate. In an embodiment, the substrate comprises a material having a refractive index of about 1.5 or less.

Another embodiment provides a method for fabricating a photorefractive device comprising the steps of forming a photorefractive layer; forming one or more transparent electrode layer; forming one or more sol-gel buffer layer; forming one or more polymer buffer layer; and interposing the one or polymer buffer layer and the one or more sol-gel buffer layer between the transparent electrode layer and the photorefractive layer. In an embodiment, the one or more sol-gel buffer layer is adjacent to the one or more transparent electrode layer and the one or more polymer buffer layer is adjacent to the photorefractive layer.

In an embodiment, a sol-gel solution is used to form the sol-gel buffer layer. The sol-gel solution can be prepared using methods known to those having ordinary skill in the art in view of the guidance provided herein. In an embodiment, the sol-gel solution is prepared by dissolving sol-gel precursors into an alcohol, such as absolute alcohol, at a volume ratio in the range of about 2:1 to about 5:1. The solution can be stirred at elevated temperatures, e.g. about 60 degrees C., for about 10 minutes. Acid can then be added followed by additional stiffing. For example, 1˜10% 0.2 M HCl is added to the solution and stirred for at least 4 hours at 60 degree C. Then, about 1˜10% of distilled water is added and stirred for about 2 hours at 60 degrees C. After cooling the solution down to room temperature, it can be mixed with 20%˜60% zirconium (IV) propoxide/methyl methacrylate (MMA) solution (which is pre-prepared by mixing MMA solution and Zirconium (IV) propoxide 70% 1-propanol solution at volume ratio 1:(2˜6) and stiffing at room temperature for over 4 hours) and stirred at room temperature for at least 72 hours to provide total dissolution.

The sol-gel buffer layer can be applied to the photorefractive device using known methods. In an embodiment, the sol-gel buffer layer is applied by coating the prepared sol-gel solution on a transparent electrode layer (e.g. ITO), which can be coated on a glass substrate by spin coating or solvent casting. The material can then be heat treated up to approximately 160° C. at a predetermined heating program for a total of about 5 to about 7 hours to form a 0.1˜4 μm, preferably a 0.1˜2 μm, thick sol-gel buffer layer on the transparent electrode layer.

In an embodiment, the sol-gel buffer layer is prepared by dipping the an electrode, such as an ITO coated glass substrate, into the sol-gel solution. Afterward, the glass substrate is pulled out of the solution slowly at a predetermined speed. Removal of film on the glass side can be performed by using acetone. Then, the substrate is cured at approximately 160° C. at a predetermined heating program for total of about 5 to about 7 hours to form a 0.1˜4 μm, preferably a 0.1˜2 μm, thick sol-gel buffer layer on the transparent electrode layer.

The polymer buffer layer can be prepared by dissolving a polymer powder selected from APC, PMMA, polyvinylcarbazole, polyarylate, or polyimide in cyclopentanone at a weight ratio of (10-30):(90-70), stiffing the resultant solution under ambient conditions for at least 12 hours to provide substantially total dissolution, and then filtering the resultant solution.

In an embodiment, the polymer buffer layer is prepared by applying the buffer polymer solution on top of the sol-gel buffer layer coated onto an electrode layer. In an embodiment, the polymer buffer layer is applied by spin coating or solvent casting, then performing a heat treatment up to approximately 100° C. at a predetermined heating program for a total of about 5 to about 7 hours. The remaining solvent can be removed by vacuum heating at about 120-140° C. for 0.5-2 hours to form a 1˜16 μm, preferably a 1˜8 μm, thick buffer layer on the sol-gel buffer layer.

Another embodiment provides a method for manufacturing the photorefractive device by: (1) forming a first transparent electrode layer on a first substrate layer to obtain a first transparent electrode, (2) forming a second transparent electrode layer on a second substrate layer to obtain a second transparent electrode, (3) respectively forming a sol-gel buffer layer on the first and/or second transparent electrode layers by spin coating or solvent casting or dip coating to form a first and/or a second sol-gel buffer layer, and (4) respectively forming a polymer buffer layer on the first and/or second sol-gel buffer layers by spin coating or solvent casting to form a first and/or a second polymer buffer layer, and (5) interposing a photorefractive layer between the two polymer buffer layers.

The electric breakdown strength of the photorefractive device comprising multiple buffer layers can be significantly improved as compared to a photorefractive device which comprises only one kind of buffer layers, when measured by an approximate 532 nm laser beam. At much higher operation bias, surprisingly faster rising and decay times are achieved. Additionally, higher grating performances under single nanosecond pulse recording conditions have been measured in the photorefractive devices described herein.

In an embodiment, the electric breakdown bias for the fabricated photorefractive device comprising one or more sol-gel buffer layers and one or more polymer buffer layers is increased by over 30% compared to a photorefractive device containing only one or more polymer buffer layers with equal buffer layer thickness, when measured by an approximate 532 nm laser beam. In an embodiment, the grating rising and decay dynamics for the fabricated photorefractive device comprising one or more sol-gel buffer layers and one or more polymer buffer layers is over 2.5 times quicker at higher operation bias compared to a photorefractive device containing only one or more polymer buffer layers with equal buffer layer thickness operated at 30% lower bias, when measured by an approximate 532 nm laser beam. In an embodiment, the single pulse grating signal for the fabricated photorefractive device comprising one or more sol-gel buffer layers and one or more polymer buffer layers is over 4.5 times larger at higher operation bias compared to a photorefractive device containing only one or more polymer buffer layers with equal buffer layer thickness operated at 30% lower bias, when measured by an approximate 532 nm laser beam. Photorefractive devices based upon the design described herein may be used for a variety of purposes including, but not limited to, 3D holographic display, dynamic holography, optical image processing, phase conjugated mirrors, signal amplification, optical computing, parallel optical logic, and pattern recognition materials and devices.

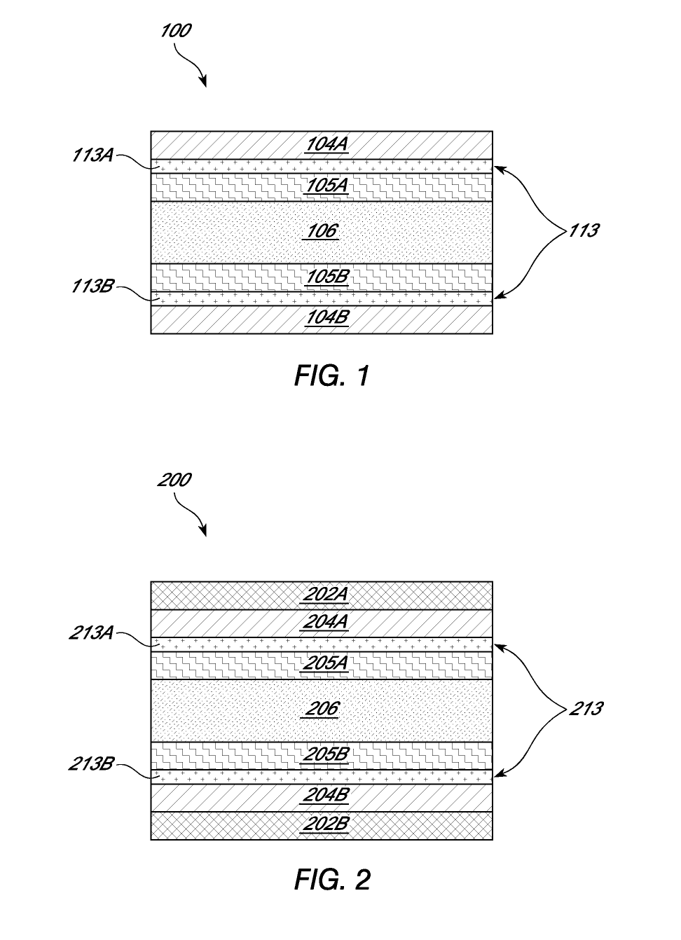

FIG. 1 shows an embodiment of the present application. FIG. 1 provides a photorefractive device 100, which comprises one or more transparent electrode layers 104, one or more sol-gel buffer layers 113, one or more polymer buffer layers 105, and a photorefractive layer 106. In an embodiment, the device may comprise more than one transparent electrode layer 104A, 104B. In an embodiment, the device may comprise more than one sol-gel buffer layer 113A, 113B. In an embodiment, the device may comprise more than one polymer buffer layer 105A, 105B. It is also contemplated that the photorefractive device comprises a single transparent electrode layer, a single sol-gel buffer layer, and a single polymer buffer layer.

In an embodiment, the sol-gel buffer layer 113 is interposed between the transparent electrode layer 104 and the polymer buffer layer 105. In an embodiment, the polymer buffer layer 105 is interposed between the sol-gel buffer layer 113 and the photorefractive layer 106. The thicknesses of the sol-gel buffer layer and the polymer buffer layer can vary.

Another embodiment provides a photorefractive device 100, which comprises a first transparent electrode layer 104A and a second transparent electrode layer 104B, a first sol-gel buffer layer 113A and a second sol-gel buffer layer 113B, a first polymer buffer layer 105A and a second polymer buffer layer 105B, and a photorefractive layer 106. In an embodiment, the first electrode layer 104A and the second electrode layer 104A are positioned on opposite sides of the photorefractive layer 106. In an embodiment, the first sol-gel buffer layer 113A and the second sol-gel buffer layer 113B are positioned on opposite sides of the photorefractive layer 106. In an embodiment, the first polymer buffer layer 105A and the second polymer buffer layer 105B are positioned on opposite sides of the photorefractive layer 106. In an embodiment, the first sol-gel buffer layer 113A is interposed between the first electrode layer 104A and the first polymer buffer layer 105A and the first polymer layer 105A is interposed between the first sol-gel buffer layer 113A and the photorefractive layer 106. In an embodiment, the second sol-gel buffer layer 113B is interposed between the second electrode layer 104B and the second polymer buffer layer 105B, and the second polymer buffer layer 105B is interposed between the second sol-gel buffer layer 113B and the photorefractive layer 106.

The photorefractive layer 106 may have a variety of thickness values for use in a photorefractive device. In an embodiment, the photorefractive layer has a thickness in the range of about 10 μm to about 200 μm. In an embodiment, the photorefractive layer has a thickness in the range of about 25 μm to about 100 μm. Such ranges of thickness allow for the photorefractive layer to provide good grating behavior.

If more than one sol-gel buffer layers is present, then the first and second sol-gel buffer layers 113A, 113B may comprise same material or different materials. Furthermore, the thicknesses of each of the sol-gel buffer layers can be independently selected. In an embodiment, the sol-gel buffer layer(s) 113 are coated to the one or more electrode layer(s) 104 by techniques known to those skilled in the art, including, but not limited to, spin coating, solvent casting, and dip coating. The polymer buffer layer(s) 105 may subsequently be fabricated to the sol-gel buffer layer modified electrodes 104.

In an embodiment, the one or more sol-gel buffer layers 113 comprise a single layer having selected thicknesses 113A, 113B. In an embodiment, the total thickness of the sol-gel buffer layer(s) is in the range of about 0.2 μm to about 4 μm. In an embodiment, the total thickness of the sol-gel buffer layer(s) is in the range of about 0.2 μm to about 2 μm. If more than one sol-gel buffer layer is used in the device, then the thickness of each of the sol-gel buffer layers may be independently selected. For example, each individual sol-gel buffer layer may have a thickness in the range of about 0.1 μm to about 4 μm. In an embodiment, an individual sol-gel buffer layer has a thickness in the range of about 0.1 μm to about 2 μm. In an embodiment, a sol-gel buffer layer has a thickness in the range of about 0.1 μm to about 1 μm. In an embodiment, an individual sol-gel buffer layer has a thickness in the range of about 0.2 μm to about 2 μm. In an embodiment, an individual sol-gel buffer layer has a thickness in the range of about 0.2 μm to about 1 μm.

The first and second polymer buffer layers 105A, 105B may comprise same material or different materials. Additionally, the thicknesses of each of the polymer buffer layers 105A, 105B can be independently selected. In one embodiment, the polymer buffer layers 105 are coated to the one or more sol-gel buffer layer 113 by techniques known to those skilled in the art, including, but not limited to, spin coating, solvent casting. The photorefractive layer 106 is subsequently laminated to the multiple buffer layers modified electrodes 104.

In one embodiment, the one or more polymer buffer layers 105 comprise a single layer having selected thicknesses 105A, 105B. The selected thicknesses 105A, 105B may be independently selected, as necessary. In an embodiment, the total thickness of the polymer buffer layer(s) is in the range of about 2 μm to about 16 μm. If more than one polymer buffer layer is used in the device, then the thickness of each of the polymer buffer layers may be independently selected. For example, each individual polymer buffer layer may have a thickness in the range of about 1 μm to about 16 μm. In an embodiment, an individual polymer buffer layer has a thickness in the range of about 1 μm to about 12 μm. In an embodiment, an individual polymer buffer layer has a thickness in the range of about 1 μm to about 8 μm. In an embodiment, an individual polymer buffer layer has a thickness in the range of about 2 μm to about 12 μm. In an embodiment, an individual polymer buffer layer has a thickness in the range of about 2 μm to about 8 μm. In an embodiment, an individual polymer buffer layer has a thickness in the range of about 2 μm to about 6 μm.

In an embodiment, the polymer buffer layer 105 comprises at least one polymer selected from the group consisting of PMMA, APC, polyimide, polyvinylcarbazole, polyarylate, and combinations thereof. In preferred embodiments, the polymer is selected from the group consisting of APC, polyarylate and PMMA.

In one embodiment, the electrode 104 comprises a transparent electrode layer 104. The transparent electrode layer 104 is further configured as a conducting film. The electrode material comprising the conducting film may be independently selected from the group consisting of metal oxides, metals, and organic films with an optical density of 0.2 or less. Non-limiting examples of transparent electrode layers 104 comprise indium tin oxide (ITO), tin oxide, zinc oxide, gold, aluminum, polythiophene, polyaniline, and combinations thereof. Preferably, the transparent electrodes 104 are independently selected from the group consisting of indium tin oxide and zinc oxide.

Another embodiment of a photorefractive device 200 is illustrated in FIG. 2. In an embodiment, the photorefractive device 200 comprises one or more substrate layers 202, one or more transparent electrode layers 204, one or more sol-gel buffer layers 213, one or more polymer buffer layers 205, and a photorefractive layer 206.

In one embodiment, a pair of electrode layers 204A, 204B is interposed between a pair of substrate layers 202A, 202B, and a photorefractive layer 206 is interposed between the pair of the electrode layers 204A, 204B. In an embodiment a first sol-gel buffer layer 213A is interposed between a first polymer buffer layer 205A and the first transparent electrode layer 204A, and the first polymer buffer layer 205A is interposed between the first sol-gel buffer layers 213A and the photorefractive layer 206. In an embodiment, a second sol-gel buffer layer 213B is interposed between a second polymer buffer layer 205B and the second transparent electrode layer 204B, and the second polymer buffer layer 205B is interposed between the second sol-gel buffer layers 213B and the photorefractive layer 206.

The one or more substrate layers can be formed from various materials. Non-limiting examples of materials that can be present in the substrate layers 202 include soda lime glass, silica glass, borosilicate glass, gallium nitride, gallium arsenide, sapphire, quartz glass, polyethylene terephthalate, and polycarbonate. Preferably the substrate 202 comprises a material with a refractive index of 1.5 or less.

In one embodiment, the photorefractive composition in the photorefractive layer comprises a polymer or an inorganic material exhibiting photorefractive behavior. In an embodiment, the polymer possesses a refractive index of approximately 1.7. Preferred non-limiting examples include photorefractive compositions comprising a polymer matrix with at least one of a repeat unit including a moiety having photoconductive or charge transport ability and a repeat unit including a moiety having non-linear optical ability, as discussed in greater detail below. Optionally, the composition may further comprise other components, such as repeat units including another moiety having non-linear optical ability, as well as sensitizers and plasticizers, as described in U.S. Pat. No. 6,610,809 to Nitto Denko Corporation and hereby incorporated by reference. One or both of the photoconductive and non-linear optical components are incorporated as functional groups into the polymer structure, typically as side groups.

The group that provides the charge transport functionality may be any group known in the art to provide such capability. If this group is to be attached to the polymer matrix as a side chain, then the group should be capable of being incorporated into a monomer that can be polymerized to form the polymer matrix of the photorefractive composition.

Non-limiting examples of the photoconductive, or charge transport, groups are illustrated below. In one embodiment, the photoconductive groups comprise phenyl amine derivatives, such as carbazoles and di- and tri-phenyl diamines. In a preferred embodiment, the moiety that provides the photoconductive functionality is selected from the group of phenyl amine derivates consisting of the following side chain structures (I), (II) and (III):

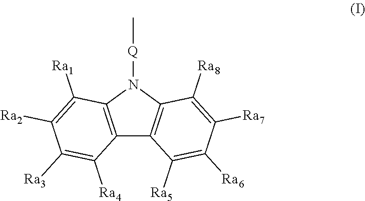

wherein Q represents alkylene or heteroalkylene group; Ra₁-Ra₈ are each independently selected from the group consisting of hydrogen, linear or branched C₁-C₁₀ alkyl, and C₆-C₁₀ aryl group;

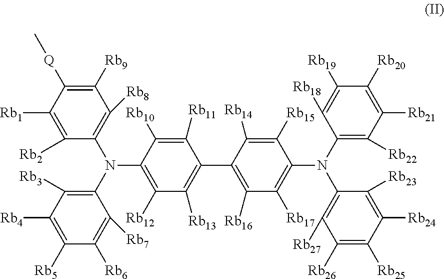

wherein Q represents alkylene or heteroalkylene group; and Rb₁-Rb₂₇ are each independently selected from the group consisting of hydrogen, linear or branched C₁-C₁₀ alkyl, and C₆-C₁₀ aryl group.

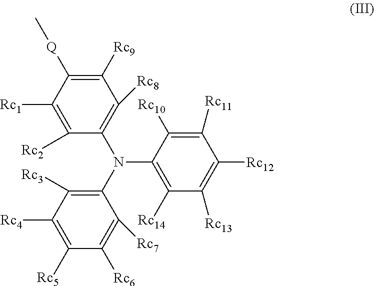

wherein Q represents alkylene or heteroalkylene group; and Rc₁-Rc₁₄ are each independently selected from the group consisting of hydrogen, linear or branched C₁-C₁₀ alkyl, and C₆-C₁₀ aryl group.

The chromophore, or group that provides the non-linear optical functionality may be any group known in the art to provide such capability. If this group is to be attached to the polymer matrix as a side chain, then the group, or a precursor of the group, should be capable of incorporation into a monomer that can be polymerized to form the polymer matrix of the composition.

The chromophore of the present disclosure is represented by the following structure (0):

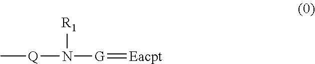

wherein Q represents alkylene or heteroalkylene group having at least one of heteroatoms selected from S and O, and preferably Q is an alkylene group represented by (CH2)p (p=2˜6); R₁ represents hydrogen, linear or branched C1-C10 alkyl, and C6-C10 aryl, and preferably R₁ is an alkyl group selected from methyl, ethyl, propyl, butyl, pentyl and hexyl group; G represents π-conjugated group; and Eacpt represents electron acceptor group. Preferably Q is selected from the group consisting of ethylene, propylene, butylene, pentylene, hexylene, and heptylene.

In this context, the term “a bridge of π-conjugated bond” refers to a molecular fragment that connects two or more chemical groups by π-conjugated bond. A π-conjugated bond contains covalent bonds between atoms that have σ bonds and π bonds formed between two atoms by overlap of their atomic orbits (s+p hybrid atomic orbits for σ bonds; p atomic orbits for π bonds).

The term “electron acceptor” refers to a group of atoms with a high electron affinity that can be bonded to a π-conjugated bridge. Exemplary acceptors, in order of increasing strength, are: C(O)NR²<C(O)NHR<C(O)NH₂<C(O)OR<C(O)OH<C(O)R<C(O)H<CN<S(O)₂R<NO₂, wherein R and R² are each independently selected from the group consisting of hydrogen, linear or branched C₁-C₁₀ alkyl, and C₆-C₁₀ aryl group.

As typical exemplary electron acceptor groups, functional groups which are described in U.S. Pat. No. 6,267,913, hereby incorporated by reference, can be used. At least a portion of these electron acceptor groups are shown in the structures below. The symbol “ [symbol] ” in the chemical structures below specifies an atom of attachment to another chemical group and indicates that the structure is missing a hydrogen that would normally be implied by the structure in the absence of the “ [symbol] ”;

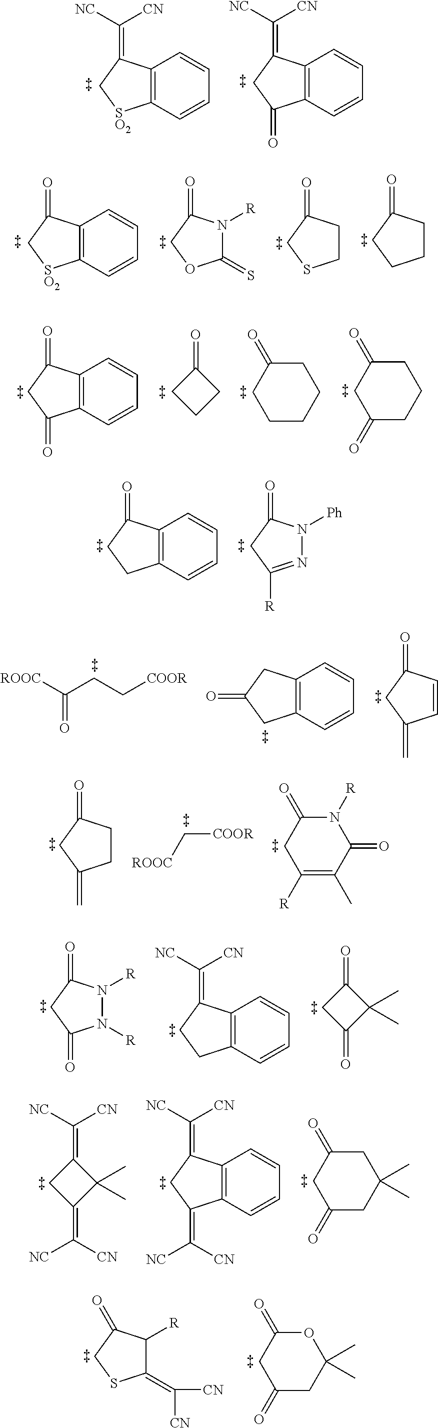

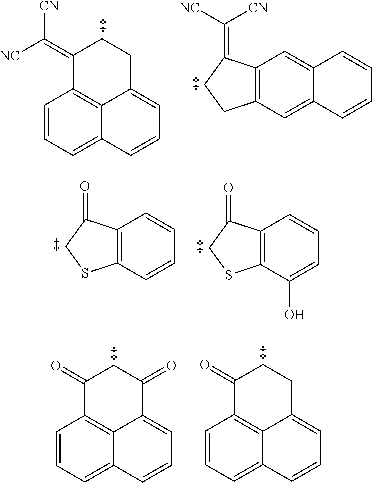

wherein R in the above structures represents hydrogen, linear or branched C₁-C₁₀ alkyl, and C₆-C₁₀ aryl group.

Preferred chromophore groups are aniline-type groups or dehydronaphthyl amine groups.

Most preferably, the moiety that provides the non-linear optical functionality is such a case that G in the structure (0) is represented by a structure selected from the group consisting of structures (IV) and (V):

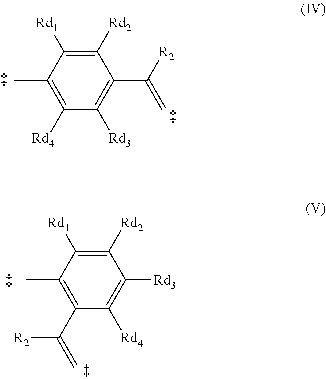

wherein Rd₁-Rd₄ in (IV) and (V) are each independently selected from the group consisting of hydrogen, linear or branched C₁-C₁₀ alkyl, C₆-C₁₀ aryl, and preferably Rd₁-Rd₄ are all hydrogen; and R₂ in (IV) and (V) is independently selected from the group consisting of hydrogen, linear or branched C₁-C₁₀ alkyl, and C₆-C₁₀ aryl group.

In an embodiment, Eacpt in the structure (0) is an electron-acceptor group represented by a structure selected from the group consisting of the following:

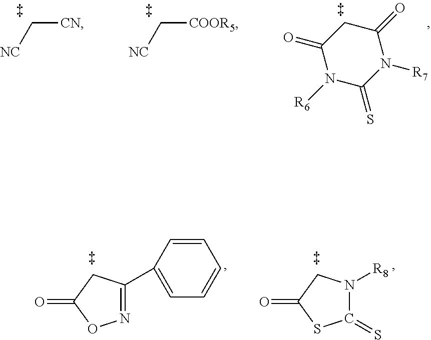

wherein R₅, R₆, R₇ and R₈ are each independently selected from the group consisting of hydrogen, linear or branched C₁-C₁₀ alkyl, and C₆-C₁₀ aryl group.

In one embodiment, material backbones, including, but not limited to, polyurethane, epoxy polymers, polystyrene, polyether, polyester, polyamide, polyimide, polysiloxane, and polyacrylate with the appropriate side chains attached, may be used to make the material matrices of the present disclosure. Preferred types of backbone units are those based on acrylates or styrene.

Particularly preferred are acrylate-based monomers, and more preferred are methacrylate monomers. The first polymeric materials to include photoconductive functionality in the polymer itself were the polyvinyl carbazole materials developed at the University of Arizona. However, these polyvinyl carbazole polymers tend to become viscous and sticky when subjected to the heat-processing methods typically used to form the polymer into films or other shapes for use in photorefractive devices.

In contrast, (meth)acrylate-based, and more specifically acrylate-based, polymers, have much better thermal and mechanical properties. That is, they provide better workability during processing by injection-molding or extrusion, for example. This is particularly true when the polymers are prepared by radical polymerization.

The photorefractive polymer composition, in an embodiment, is synthesized from a monomer incorporating at least one of the above photoconductive groups or one of the above chromophore groups. It is recognized that a number of physical and chemical properties are also desirable in the polymer matrix. It is preferred that the polymer incorporates both a charge transport group and a chromophore group, so the ability of monomer units to form copolymers is preferred. Physical properties of the formed copolymer that are of importance include, but are not limited to, the molecular weight and the glass transition temperature, Tg. Also, it is valuable and desirable, although optional, that the composition should be capable of being formed into films, coatings and shaped bodies of various kinds by standard polymer processing techniques, such as solvent coating, injection molding, and extrusion.

In the present invention, the polymer generally has a weight average molecular weight, Mw, in the range of from about 3,000 to about 500,000, preferably from about 5,000 to about 100,000. The term “weight average molecular weight” as used herein means the value determined by the GPC (gel permeation chromatography) method using polystyrene standards, as is well known in the art.

Further non-limiting examples of monomers including a phenyl amine derivative group as the charge transport component include carbazolylpropyl (meth)acrylate monomer; 4-(N,N-diphenylamino)-phenylpropyl (meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(l,r-biphenyl)-4,4′-diamine. Such monomers can be used singly or in mixtures of two or more monomers.

Further non-limiting examples of monomers including a chromophore group as the non-linear optical component include N-ethyl, N-4-dicyanomethylidenyl acrylate and N-ethyl, N-4-dicyanomethylidenyl-3,4,5,6,10-pentahydronaphtylpentyl acrylate.

Diverse polymerization techniques are known in the art to manufacture polymers from the above discussed monomers. One such conventional technique is radical polymerization, which is typically carried out by using an azo-type initiator, such as AIBN (azoisobutyl nitrile). In this radical polymerization method, the polymerization catalysis is generally used in an amount of from about 0.01 to 5 mol %, preferably from about 0.1 to 1 mol %, per mole of the sum of the polymerizable monomers.

In one embodiment of the present disclosure, conventional radical polymerization can be carried out in the presence of a solvent, such as ethyl acetate, tetrahydrofuran, butyl acetate, toluene or xylene. The solvent is generally used in an amount of 100˜10000 wt %, and preferably 1000˜5000 wt %, per weight of the sum of the polymerizable monomers.

In an alternative embodiment, conventional radical polymerization is carried out without a solvent in the presence of an inert gas. In one embodiment, the inactive gas comprises one of nitrogen, argon, and helium. The gas pressure during polymerization is 1˜50 atm. and preferably 1˜5 atm. The conventional radical polymerization is preferably carried out at a temperature of 50˜100° C. and is allowed to continue for 1˜100 hours, depending on the desired final molecular weight and polymerization temperature and taking into account the polymerization rate.

By carrying out the radical polymerization technique based on the teachings and preferences given above, it is possible to prepare polymers having charge transport groups, polymers having non-linear optical groups, and random or block copolymers carrying both charge transport and non-linear optical groups. Polymer systems may further be prepared from combinations of these polymers. Additionally, by following the techniques described herein, it is possible to prepare such materials with exceptionally good properties, such as photoconductivity, response time, and diffraction efficiency.

If the polymer is prepared from monomers that provide only charge transport ability, the photorefractive composition of the invention can be made by dispersing a component that possesses non-linear optical properties through the polymer matrix, as is described in U.S. Pat. No. 5,064,264 to IBM, which is incorporated herein by reference. Suitable materials are known in the art and are well described in the literature, such as D. S. Chemla & J. Zyss, “Nonlinear Optical Properties of Organic Molecules and Crystals” (Academic Press, 1987), incorporated herein by reference. Also, as described in U.S. Pat. No. 6,090,332 to Seth R. Marder et. al., hereby incorporated by reference, fused ring bridge, ring locked chromophores that form thermally stable photorefractive compositions can be used.

Chromophores may also be added to the photorefractive composition as ingredients distinct from the polymer. For typical, non-limiting examples of chromophore additives, the following chemical structure compounds can be used:

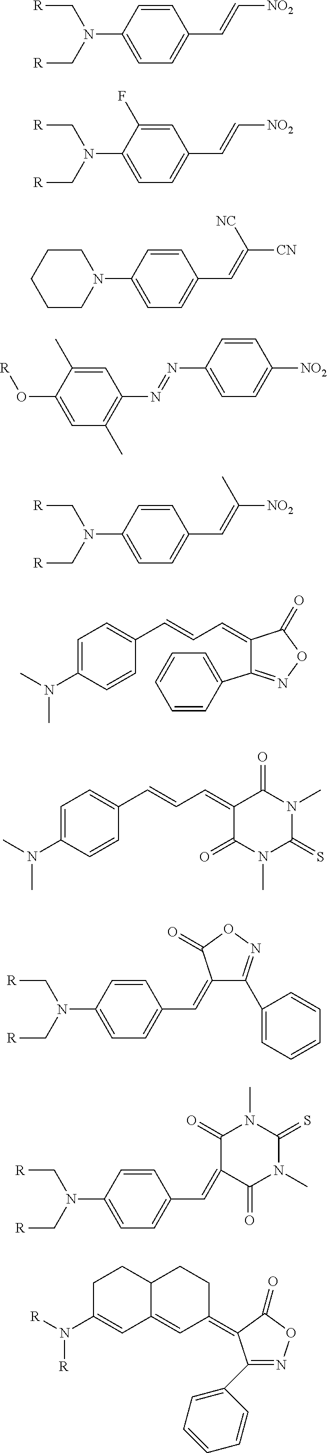

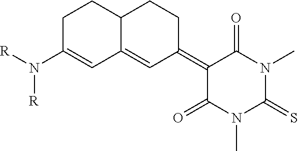

wherein R in the above compounds represents hydrogen or a linear or branched C₁-C₁₀ alkyl.

The selected compound or compounds may be mixed in the matrix copolymer in a concentration of less than 80 wt %, more preferably less than 40 wt %. On the other hand, if the polymer is prepared from monomers that provide only the non-linear optical ability, the photorefractive composition can be made by mixing a component that possesses charge transport properties into the polymer matrix, again as is described in U.S. Pat. No. 5,064,264 to IBM. Preferred charge transport compounds are good hole transfer compounds, for example, N-alkyl carbazole or triphenylamine derivatives.

As an alternative, or in addition to, adding the charge transport component in the form of a dispersion of entities comprising individual molecules with charge transport capability, a polymer blend can be made of individual polymers with charge transport and non-linear optical abilities. For the charge transport polymer, the polymers already described above, such as those containing phenyl-amine derivative side chains, can be used. Since polymers containing only charge transport groups are comparatively easy to prepare by conventional techniques, the charge transport polymer may be made by radical polymerization or by any other convenient method.

An embodiment provides a method of manufacturing a photorefractive device, comprising forming one or more transparent electrode layers, forming a photorefractive layer, interposing one or more sol-gel buffer layers between the one or more transparent electrode layers and the photorefractive layer, and interposing one or more polymer buffer layers between the one or more transparent electrode layers and the photorefractive layer.

In an embodiment, the device comprises first and second transparent electrode layers positioned on opposite sides of the photorefractive layer, first and second sol-gel buffer layers positioned on opposite sides of the photorefractive layer, and first and second polymer buffer layers positioned on opposite sides of the photorefractive layer. In an embodiment, the first sol-gel buffer layer is interposed between the first electrode layer and the first polymer buffer layer and the first polymer layer is interposed between the first sol-gel buffer layer and the photorefractive layer. In an embodiment, the second sol-gel buffer layer is interposed between the second electrode layer and the second polymer buffer layer and the second polymer buffer layer is interposed between the second sol-gel buffer layer and the photorefractive layer.

### EXAMPLES

The benefits described above are further illustrated by the following examples, which are intended to be illustrative of the embodiments of the disclosure, but are not intended to limit the scope or underlying principles in any way.

### (a) Sol-Gel Material Precursors

Methacryloxypropyltrimethoxysilane (MATMS), methyl methacrylate (MMA), zirconium (IV) propoxide 70% 1-propanol solution, 0.2 M HCl, and absolute alcohol are commercially available from Aldrich and were used without further processing.

### (b). Preparation of Sol-Gel Solution

The sol-gel solutions were prepared by dissolving sol-gel precursor MATMS into absolute alcohol at a volume ratio ranging from about 2:1 to about 5:1 and stirring at 60 degrees C. for about 10 minutes. About 1˜10% 0.2 M HCl was then added to the solution, which was then stirred at least 4 hours at about 60 degree C. Then about 1˜10% of distilled water was added to the solution and stirred at least 2 hours at 60 degree C. After cooling the solution down to room temperature, the solution was then mixed with about 20%˜60% zirconium (IV) propoxide/MMA) solution, which is pre-prepared by mixing MMA solution and zirconium (IV) propoxide 70% 1-propanol solution at volume ratio about 1:2 to about 1:6 and stirring at room temperature for over 4 hours. The solution was stirred at room temperature for at least 72 hours to provide total dissolution.

### (c). Preparation of Sol-Gel Buffer Layer

The sol-gel buffer layer, preferably having a high dielectric constant, was prepared by applying the sol-gel solution on a transparent electrode layer, such as ITO, which was coated on a glass substrate by spin coating, solvent casting, or dip coating. Upon application of the sol-gel solution, the material was heat treated up to approximately 160° C. using a predetermined heating program for total of about 5-7 hours to form a 0.1˜1 μm thick sol-gel buffer layer on the transparent electrode layer.

### (d) Preparation of Polymer Solution

The polymer solutions were prepared by dissolving about 10% to about 45% polymer (APC, PMMA, polyarylate, polyvinylcarbazole or polyimide) powder by weight in cyclopentanone. The polymer solution was stirred under ambient conditions for at least 12 hours to provide substantially total dissolution, and then filtered using an approximately 0.2 μm PTFE filter.

### (e) Preparation of Polymer Buffer Layer on Top of Sol-Gel Coated ITO Glass Substrate

The polymer solution was applied to the sol-gel coated glass substrate by spin-coating or solvent casting. The solvent components of the polymer buffer layer were removed from the applied mixture by heat treatment up to 100° C. at a predetermined heating program for about 6 hours. The applied mixture was further subjected to vacuum heating at about 130° C. for about 1 hour to form a polymer buffer layer on the electrode having a thickness in the range of about 1 μm to an about 8 μm.

### (f) Synthesis of Non-Linear-Optical Chromophore 7-FDCST

The non-linear-optical precursor, 4-homopiperidino-2-fluorobenzylidene malononitrile, (“7-FDCST”) was synthesized according to the following two-step synthesis scheme:

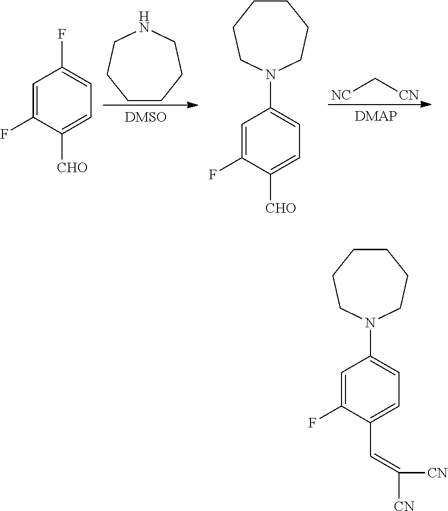

A mixture of 2,4-difluorobenzaldehyde (25 g or 176 mmol), homopiperidine (17.4 g or 176 mmol), lithium carbonate (65 g or 880 mmol), and DMSO (625 mL) was stirred at 50° C. for 16 hours. Water (50 mL) was added to the reaction mixture. The products were extracted with ether (100 mL). After removal of ether, the crude products were purified by silica gel column chromatography using hexanes-ethyl acetate (9:1) as an eluent and crude intermediate was obtained (22.6 g,). 4-(Dimethylamino)pyridine (230 mg) was added to a solution of the 4-homopiperidino-2-fluorobenzaldehyde (22.6 g or 102 mmol) and malononitrile (10.1 g or 153 mmol) in methanol (323 mL). The reaction mixture was kept at room temperature and the product was collected by filtration and purified by recrystallization from ethanol. The final product yield was 18.1 g (38%).

### (g) Monomers Containing Charge Transport Groups—TPD Acrylate Monomer:

Triphenyl diamine type (N-[acroyloxypropylphenyl]-N,N′,N′-triphenyl-(1,1′-biphenyl)-4,4′-diamine) (TPD acrylate) were purchased from Wako Chemical, Japan. The TPD acrylate type monomers have the structure:

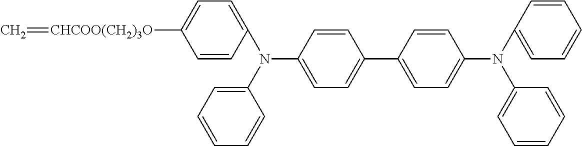

### (h) Monomers Containing Non-Linear-Optical Groups

The non-linear-optical precursor monomer 5-[N-ethyl-N-4-formylphenyl]amino-pentyl acrylate was synthesized according to the following synthesis scheme:

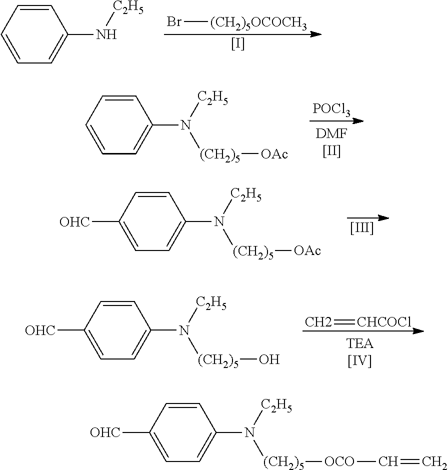

### Step I:

In a solution of bromopentyl acetate (about 5 mL or 30 mmol) and toluene (about 25 mL), triethylamine (about 4.2 mL or 30 mmol) and N-ethylaniline (about 4 mL or 30 mmol) were added at about room temperature. This solution was heated to about 120° C. overnight. After cooling down, the reaction mixture was rotary-evaporated. The residue was purified by silica gel chromatography (developing solvent: hexane/acetone=about 9/1). An oily amine compound was obtained. (Yield: about 6.0 g (80%))

### Step II:

Anhydrous DMF (about 6 mL or 77.5 mmol) was cooled in an ice-bath. Then, POCl₃ (about 2.3 mL or 24.5 mmol) was added dropwise into a roughly 25 mL flask, and the mixture was allowed to come to room temperature. The amine compound (about 5.8 g or 23.3 mmol) was added through a rubber septum by syringe with dichloroethane. After stirring for about 30 min., this reaction mixture was heated to about 90° C. and the reaction was allowed to proceed overnight under an argon atmosphere.

After the overnight reaction, the reaction mixture was cooled, and poured into brine water and extracted by ether. The ether layer was washed with potassium carbonate solution and dried over anhydrous magnesium sulfate. After removing the magnesium sulfate, the solvent was removed and the residue was purified by silica gel chromatography (developing solvent: hexane/ethyl acetate=about 3/1). An aldehyde compound was obtained. (Yield: about 4.2 g (65%))

### Step III:

The aldehyde compound (about 3.92 g or 14.1 mmol) was dissolved with methanol (about 20 mL). Into this mixture, potassium carbonate (about 400 mg) and water (about 1 mL) were added at room temperature and the solution was stirred overnight. The next day, the solution was poured into brine water and extracted by ether. The ether layer was dried over anhydrous magnesium sulfate. After removing the magnesium sulfate, the solvent was removed and the residue was purified by silica gel chromatography (developing solvent: hexane/acetone=about 1/1). An aldehyde alcohol compound was obtained. (Yield: about 3.2 g (96%))

### Step IV:

The aldehyde alcohol (about 5.8 g or 24.7 mmol) was dissolved with anhydrous THF (about 60 mL). Into the solution, triethylamine (about 3.8 mL or 27.1 mmol) was added and the solution was cooled by ice-bath. Acrolyl chloride (about 2.1 mL or 26.5 mmol) was added and the solution was maintained at 0° C. for 20 minutes. Thereafter, the solution was allowed to warm up to room temperature and stirred at room temperature for 1 hour, at which point TLC indicated that all of the alcohol compound had disappeared. The solution was poured into brine water and extracted by ether. The ether layer was dried over anhydrous magnesium sulfate. After removing the magnesium sulfate, the solvent was removed and the residue acrylate compound was purified by silica gel chromatography (developing solvent: hexane/acetone=about 1/1). The compound yield was about 5.38 g (76%), and the compound purity was about 99% (by GC).

### (i) Synthesis of Matrix Polymer for Use in the Photorefractive Material

A charge transport monomer N-[(meth)acroyloxypropylphenyl]-N,N′,N′-triphenyl-(1,1′-biphenyl)-4,4′-diamine (TPD acrylate) (43.34 g), and a non-linear-optical precursor monomer 5-[N-ethyl-N-4-formylphenyl]amino-pentyl acrylate (4.35 g), prepared as described above, were introduced into a three-necked flask. After toluene (400 mL) was added and purged by argon gas for 1 hour, azoisobutylnitrile (118 mg) was added into this solution. Then, the solution was heated to 65° C., while continuing to purge with argon gas.

After about 18 hours of polymerization, the polymer solution was diluted with toluene. The polymer was precipitated from the solution and added to methanol, and the resulting polymer precipitate was collected and washed in diethyl ether and methanol. The white polymer powder was collected and dried. The yield of polymer was about 66%.

The weight average and number average molecular weights were measured by gel permeation chromatography, using polystyrene standards. The results were Mn=about 10,600, Mw=about 17,100, giving a polydispersity of about 1.61.

To form the polymer with non-linear-optical capability, the precipitated precursor polymer (5.0 g) was dissolved with chloroform (24 mL). Into this solution, dicyanomalonate (1.0 g) and dimethylaminopyridine (40 mg) were added, and the reaction was allowed to proceed overnight at 40° C. As before, the polymer was recovered from the solution by filtration of impurities, followed by precipitation into methanol, washing and drying.

### (j) Plasticizer

N-ethylcarbazole is commercially available from Aldrich and was used after recrystallization.

### (k) Sensitizer

PCBM [C60] is commercially available from America Dye Sources and was used without further processing.

### (l) Preparation of Photorefractive Material

The photorefractive material was prepared with the following components:

| | |
|---|---|
| (i) Matrix polymer (described above): | ~50 wt % |
| (ii) Prepared chromophore of 7-FDCST | ~30 wt % |
| (iii) Ethyl carbazole plasticizer | ~20 wt % |
| (iv) PCBM[C60] | ~0.4 wt % |

To prepare the photorefractive composition, the components listed above were dissolved with toluene and stirred overnight at room temperature. After removing the solvent by rotary evaporator and vacuum pump, the residue was gathered. This residue mixture—which is used to form the photorefractive material—was put on a slide glass and melted at about 125° C. to make an approximately 200-300 μm thickness film, or pre-cake.

### Example 1

### Preparation of Photorefractive Devices

A photorefractive device was prepared having generally the same structure and components as shown in FIG. 2. From the outer layers to the inner layer were: two ITO-coated glass substrates (electrode and substrate), two sol-gel buffer layers, two polymer buffer layers, and a photorefractive layer. The photorefractive device was fabricated using the following steps:

(i) Sol-gel solution: About 30 ml of MATMS was mixed with about 10 ml of absolute alcohol and stirred at about 60 degrees C. for about 10 minutes. Thereafter, about 2 ml of 0.2M HCl was added and stirred for about 4 hours at 60 degrees C. Then, about 3 ml of distilled water was added and stirred for about 2 hours at 60 degrees C. After cooling the solution down to room temperature, the solution was then mixed with about 17 ml of zirconium (IV) propoxide/MMA solution (about 4 ml MMA and about 13 ml zirconium (IV) propoxide 70% 1-propanol) and stirred at room temperature for about 72 hours to provide total dissolution.

(ii) Sol-gel buffer coated on an ITO coated glass substrate: The sol-gel buffer layer was prepared by dipping an ITO coated glass substrate into the sol-gel solution, and then the glass substrate was pulled out of the solution slowly. After removing the film on the glass side by acetone, the substrate was cured at approximately 160° C. at for a total of about 7 hours to form an about 0.8 μm thick sol-gel buffer layer on the transparent electrode layer.

(iii) Polymer Solution: About 20% by weight of APC powder was dissolved in cyclopentonone.

(iv) Forming Polymer Buffer Layer on top of sol-gel buffer layer: The APC polymer solution was applied by spin coating onto the sol-gel buffer coated ITO film and dried at about 100° C. for about 6 hours. The applied solution was further subjected to vacuum heating at 130° C. for about 1 hour. These steps provided an APC polymer buffer layer having a thickness of about 2 μm.

(v) Assembling the Photorefractive Device: The photorefractive film or pre-cake was transferred from the glass plate and interposed between the two polymer buffer layers to form a photorefractive device as shown in FIG. 2. The thickness for the photorefractive layer was controlled to be about 104 μm by glass beads spacers.

### Comparative Example 1

A photorefractive device was obtained in the same manner as in the Example 1, except that it was fabricated without the sol-gel buffer layer and without the APC polymer buffer layer. As such, the device of Comparative Example 1 had a photorefractive layer adjacent two electrodes comprising bare ITO glass.

### Comparative Example 2

A photorefractive device was obtained in the same manner as in Example 1, except that it was fabricated without the sol-gel buffer layer. However, unlike Comparative Example 1, the device of Comparative Example 3 did comprise an APC polymer buffer layer which was about 2 μm thick.

### Comparative Example 3

A photorefractive device was obtained in the same manner as in the Comparative Example 2 except the APC polymer buffer layers were about 20 μm thick. The device did not have sol-gel buffer layers.

### Measurement of Electric Breakdown Strength

The electric breakdown strength was measured as the statistic results of 10 pieces of photorefractive devices fabricated according to the description above. Each device was tested upon step increased applied voltage at the rate of 1 KV/min until electric failure of the device occurred. The voltage at the point in which the device electrically broke down was then recorded.

### Measurement of Diffraction Efficiency and Overmodulation Voltage

The diffraction efficiency was measured as a function of the applied field, by four-wave mixing experiments at about 532 nm with two s-polarized writing beams and a p-polarized probe beam. The angle between the bisector of the two writing beams and the sample normal was about 60 degrees and the angle between the writing beams was adjusted to provide an approximately 2.5 μm grating spacing in the material (about 20 degrees). The writing beams had approximately equal optical powers of about 0.45 mW/cm² after correction for reflection losses—which correlates with a total optical power of about 1.5 mW. The beams were collimated to a spot size of approximately 500 μm. The optical power of the probe was about 100 μW.

The measurement of a diffraction efficiency peak bias was performed as followings: The electric field (V/μm) applied to the photorefractive device sample was varied from 0 V/μm all the way up to 100 V/μm with a certain time period (typically 30 s), and the sample was illuminated with the two writing beams and the probe beam during the certain time period. Then, the diffracted beam was recorded. According to the theory,

$$η ∼ {sin}^{2} ( k \frac{{E}_{o} {E}_{o}^{G}}{\sqrt{1 + {( {E}_{o}^{G} / {E}_{q} )}^{2}}} )$$

where E₀^{G} is the component of E₀ along the direction of the grating wave-vector and E_{q} is the trap limited saturation space-charge field. The diffraction efficiency will show maximum peak value at the predetermined applied bias. The peak diffraction efficiency bias thus is a very useful parameter to determine the device.

### Measurement of Rising Time (Response Time) and Down Time (Decay Time)

The response time and decay time were measured as a function of the applied field, using a procedure essentially the same as that described in the diffraction efficiency measurement: four-wave mixing experiments at 532 nm with s-polarized writing beams and a p-polarized probe beam. The angle between the bisector of the two writing beams and the sample normal was 60 degrees and the angle between the writing beams was adjusted to provide a 2.5 μm grating spacing in the material (about 20 degrees). The writing beams had equal optical powers of 0.45 mW/cm² after correction for reflection losses—which correlates with a total optical power of about 1.5 mW. The beams were collimated to a spot size of approximately 500 μm. The optical power of the probe was 100 μW.

The measurement of the grating buildup time was done as follows: an electric field (V/μm) was applied to the sample corresponding to slightly below the bias peak voltage, and the sample was illuminated with two writing beams and the probe beam. Then, the evolution of the diffracted beam was recorded. The response time (rising time) and down time (decaying time) were estimated as the time required for reaching e⁻¹ of steady-state diffraction efficiency.

### Measurement of Single Pulse Photorefractive Grating Signal

The single pulse grating diffraction efficiency was measured as a function of the applied field, by four-wave mixing experiments at about 532 nm with two s-polarized 4.6 ns laser pulse with the energy of each beam to be 2 mJ/cm². The angle between the bisector of the two writing beams and the sample normal was about 60 degrees and the angle between the writing beams was adjusted to provide an approximately 2.5 μm grating spacing in the material (about 20 degrees). A p-polarization 633 nm He—Ne laser beam with 0.2 mW power incident at Bragg angle was used as the probe beam. The diffracted signal of the 633 nm beam was monitored and the single pulse diffraction efficiency was determined by follows: I_{diffracted}/T_{incident}.

The performance of each device is summarized as follows in Tables 1 and 2.

TABLE 1
Comparison of the PR devices breakdown
voltage and overmodulation voltage

| | | Breakdown | Overmodulation |
|---|---|---|---|
| Device | Buffer Layer(s) | Volatage (kV) | Volatage (kV) |
| Example 1 | 0.8 μm sol-gel layers | 11.0 ± 0.3 | 2.8 |
| | 2 μm polymer layers | | |
| Comparative | No buffers | 8.4 ± 0.5 | 6.0 |
| Example 1 | | | |
| Comparative | 2 μm polymer layers | 8.5 ± 0.3 | 2.8 |
| Example 2 | | | |
| Comparative | 20 μm polymer | 10.6 ± 0.2 | 5.2 |
| Example 3 | layers | | |

TABLE 2
Comparison of the PR devices bias peak voltage, rising
time, decay time and single pulse recording performance

| | | | | | Single Pulse | |
|---|---|---|---|---|---|---|
| | Rising (s) | | Decay (s) | | Diffraction | |
| Device | Peak Bias | 11 kV | Peak Bias | 11 kV | 8 kV | 11 kV |
| Example 1 | 0.35 | 0.12 | 1.0 | 0.2 | 12% | 23% |
| Comparative | 0.25 | X | 0.5 | X | 5% | X |
| Example 1 | | | | | | |
| Comparative | 0.35 | X | 1.0 | X | 12% | X |
| Example 2 | | | | | | |
| Comparative | 28.0 | 10.0 | 2000 | 600 | <1% | <1% |
| Example 3 | | | | | | |

X: electric breakdown.

As illustrated in Table 1, the electric breakdown bias for the fabricated photorefractive device of Example 1 increased by over 30% compared to a photorefractive device described in Comparative Examples 1 and 2, and over 5% compared to a photorefractive device described in Comparative Example 3, when measured by a 532 nm laser beam. As illustrated in Table 2, the grating rising and decay dynamics for the fabricated photorefractive device of Example 1 was over 2.5 times quicker at higher operation bias than that of a photorefractive device described in Comparative Examples 1 and 2, and over two orders of magnitude faster than that of a photorefractive device described in Comparative Example 3, when measured by a 532 nm laser beam.

The single pulse grating signal for the fabricated photorefractive device of Example 1 was over 4.5 times larger than that of a photorefractive device described in Comparative Example 1, over 2 times larger than that of a photorefractive device described in Comparative Example 2, and over 20 times larger than that of a photorefractive device described in Comparative Example 3, when measured by a 532 nm laser beam. Overall the device described in Example 1 had the best performance for dynamic holographic applications. It is believed that that the sol-gel buffer layer, in conjunction with the polymer buffer layer, improves improved performance at lower thicknesses than a device with the polymer buffer layers alone.

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims. All patents, patent publications and other documents referred to herein are hereby incorporated by reference in their entirety.

1. A photorefractive device, which comprises:
a transparent electrode layer;
a sol-gel buffer layer;
a polymer buffer layer; and
a photorefractive layer;
wherein the sol-gel buffer layer is interposed between the transparent electrode layer and the polymer buffer layer; and
wherein the polymer buffer layer is interposed between the sol-gel buffer layer and the photorefractive layer.

2. The photorefractive device of claim 1, wherein the sol-gel buffer layer comprises a sol-gel material having a dielectric constant greater than about 5.0.

3. The photorefractive device of claim 1, or wherein the polymer buffer layer comprises a polymer selected from the group consisting of polymethyl methacrylate, polyimide, amorphous polycarbonate, polyvinylcarbazole, polyarylate and combinations thereof.

4. The photorefractive device of claim 1, wherein the refractive index of the polymer buffer layer is in the range of about 1.45 to about 1.7.

5. The photorefractive device of claim 1, wherein the thickness of the sol-gel buffer layer is in the range of about 0.1 μm to about 2 μm.

6. The photorefractive device of claim 1, wherein the thickness of the polymer buffer layer is in the range of from about 1 μm to about 8 μm.

7. The photorefractive device of claim 1, further comprising a substrate attached to the electrode layer at a side opposite the polymer buffer layer, wherein said substrate comprises a material selected from the group consisting of soda lime glass, silica glass, borosilicate glass, gallium nitride, gallium arsenide, sapphire, quartz glass, polyethylene terephthalate, polycarbonate, and combinations thereof.

8. The photorefractive device of claim 7, wherein the substrate comprises a material having an index of refraction that is less than about 1.5.

9. The photorefractive device of claim 1, wherein the photorefractive layer comprises an organic or inorganic polymer exhibiting photorefractive behavior and possessing a refractive index of about 1.7.

10. A photorefractive device comprising:
a first transparent electrode layer and a second transparent electrode layer;
a first sol-gel buffer layer and a second sol-gel buffer layer;
a first polymer buffer layer and a second polymer buffer layer;
a photorefractive layer;
wherein the first transparent electrode layer and the second transparent electrode layer are positioned on opposite sides of the photorefractive layer;
wherein the first sol-gel buffer layer and the second sol-gel buffer layer are positioned on opposite sides of the photorefractive layer;
wherein the first polymer buffer layer and the second polymer buffer layer are positioned on opposite sides of the photorefractive layer;
wherein the first sol-gel buffer layer is interposed between the first transparent electrode layer and the first polymer buffer layer, and the first polymer layer is interposed between the first sol-gel buffer layer and the photorefractive layer; and
wherein the second sol-gel buffer layer is interposed between the second transparent electrode layer and the second polymer buffer layer, and the second polymer buffer layer is interposed between the second sol-gel buffer layer and the photorefractive layer.

11. The photorefractive device of claim 10, wherein the total combined thickness of the first and second sol-gel buffer layers is in the range of about 0.2 μm to about 4 μm.

12. The photorefractive device of claim 10, wherein the total combined thickness of the first and second polymer buffer layers is in the range of about 2 μm to about 16 μm.

13. The photorefractive device of claim 10, wherein at least one of the first transparent electrode layer and the second transparent electrode layer comprises a conducting film independently selected from the group consisting of metal oxides, metals, and organic films.

14. The photorefractive device of claim 13, wherein the conducting film has an optical density less than about 0.2.

15. A method of manufacturing a photorefractive device, comprising:
forming one or more transparent electrode layers;
forming a photorefractive layer;
interposing one or more sol-gel buffer layers between the one or more transparent electrode layers and the photorefractive layer; and
interposing one or more polymer buffer layers between the one or more transparent electrode layers and the photorefractive layer;
wherein the total combined thickness of the one or more polymer buffer layers is in the range of about 2 μm to about 16 μm, and the total combined thickness of the one or more sol-gel buffer layers is in the range of about 0.2 μm to about 4 μm.

16. The method of claim 15, wherein the electric breakdown strength of the photorefractive device after incorporating the one or more sol-gel buffer layers and the one or more polymer buffer layers is improved when measured by using an approximately 532 nm laser beam, relative to a photorefractive device containing at least one transparent electrode layer and a photorefractive layer without the one or more sol-gel buffer layers or the one or more polymer buffers layer interposed there between.

17. The method of claim 15, wherein:
the one or more transparent electrodes comprise first and second transparent electrode layers positioned on opposite sides of the photorefractive layer;
the one or more sol-gel buffer layers comprise first and second sol-gel buffer layers positioned on opposite sides of the photorefractive layer; and
the one or more polymer buffer layers comprise first and second polymer buffer layers positioned on opposite sides of the photorefractive layer;
wherein the first sol-gel buffer layer is interposed between the first electrode layer and the first polymer buffer layer, and the first polymer layer is interposed between the first sol-gel buffer layer and the photorefractive layer; and
wherein the second sol-gel buffer layer is interposed between the second electrode layer and the second polymer buffer layer, and the second polymer buffer layer is interposed between the second sol-gel buffer layer and the photorefractive layer.

18. The method of claim 15, wherein the one or more sol-gel buffer layers independently comprise a sol-gel material having a dielectric constant greater than about 5.0.

19. The method of claim 15, wherein the one or more polymer buffer layers comprises a polymer independently selected from the group consisting of polymethyl methacrylate, polyimide, amorphous polycarbonate, polyvinylcarbazole, polyarylate and combinations thereof.

20. The method of claim 15, wherein the refractive index of the one or more polymer buffer layers is each independently in the range of about 1.45 to about 1.7.
